(19) United States
(12) Patent Application Publication
(10) Pub. No.: US 2025/0099964 A1
(43) Pub. Date: Mar. 27, 2025

(54) NUCLEIC ACID DETECTION DEVICE

(71) Applicant: Delta Electronics, Inc., Taoyuan City (TW)

(72) Inventors: Chun-Yen Kuo, Taoyuan City (TW); Ying-Ting Chen, Taoyuan City (TW); Yu-Jen Liu, Taoyuan City (TW); Yu-Kai Kao, Taoyuan City (TW); Yu-Hong Yen, Taoyuan City (TW)

(21) Appl. No.: 18/388,068

(22) Filed: Nov. 8, 2023

(30) Foreign Application Priority Data
Sep. 22, 2023 (CN) 202311227162.4

(51) Int. Cl. B01L 7/00

(52) U.S. Cl. CPC B01L 7/52; B01L 2200/16; B01L 2300/0654; B01L 2300/1894; B01L 2400/043

(57) ABSTRACT

A nucleic acid detection device includes tube holders, an illumination module, a detection module and a driving module. The tube holders accommodates tubes, each containing a reagent and a magnetizable element. The illumination module includes light sources, a magnet and a casing, and the light sources and the magnet are installed on the casing. The driving module includes a motor, a lead screw and a slider. The lead screw is coupled to the motor and driven by the motor to rotate, and the slider is sleeved on the lead screw and has a reciprocating linear motion in response to a rotation of the lead screw. The illumination module is coupled to and moved together with the slider, so that the light sources and the magnet are synchronously driven by the motor and have reciprocating linear motions in a direction parallel to the lead screw. The magnetizable element in the tube maintains at a first position when the magnet is not aligned with the tube, while when the magnet is aligned with the tube, the magnetizable element is attracted by the magnet to move from the first position to a second position, thereby mixing the reagent in the tube.

### CROSS-REFERENCE TO RELATED APPLICATION

This application claims priority to China Patent Application No. 202311227162.4 filed on Sep. 22, 2023. The entireties of the above-mentioned patent application are incorporated herein by reference for all purposes.

### FIELD OF THE INVENTION

The present disclosure relates to a nucleic acid detection device, and more particularly to a nucleic acid detection with magnetic mixing function.

### BACKGROUND OF THE INVENTION

Due to the COVID-19 pandemic, the molecular diagnosis becomes the focus of global attention, prompting rapid growth in the demand for in vitro diagnostic (IVD) test kits and test devices. In response to the rapidly growing demand for IVD test and to achieve accurate and precise detection and analysis purposes, how to preserve the detection reagents (such as enzymes and antibodies) contained in the test kit is an important issue. If the detection reagent becomes invalid due to improper storage, it will lead to false positive or false negative test results.

In the past, if the molecular detection reagents were stored and transported in wet form, they were usually supplemented with glycerol, mineral oil or other related additives to ensure the chemical structure stabilities of the reagents in wet form. In addition, the molecular detection reagents in wet form must be stored in a low-temperature environment (such as −20° C.) and must be transported by cold chain transportation. However, the necessity of low-temperature storage and cold chain transportation for the wet reagents not only increases the cost of the test kit, but also causes inconvenience to users in storing the test kit. Moreover, the refrigeration equipment, refrigerants and coolants required for cold chain storage and transportation also cause energy loss and environmental pollution.

The above-mentioned inconvenience can be solved by the mature freeze-drying (lyophilization) technology now. By placing the frozen molecular detection reagent in a vacuum environment for dehydration and drying, a stable solid form is formed, which improves the stability of the reagent and greatly extends the shelf life of the reagent. In addition, the lyophilized reagent greatly reduce the weight and the volume thereof, and no longer needs the cold chain transportation to maintain the stability of the reagent, thus decreasing the cost and reducing the impact on the environment. During the lyophilization and storage process of the molecular detection reagent, the lyoprotectants (also called excipients) are usually supplemented to prevent denaturation of the components. The lyoprotectants can be divided into sugars, polyols, polymers, surfactants, amino acids and salts according to their ingredients.

However, each lyophilized reagent and its lyoprotectant have fixed and optimized compositions and ratios, that is, the supplemented lyoprotectant occupies a certain volume concentration. This directly results in a certain degree of concentration gradient distribution problem after the lyophilized reagent is re-dissolved in water, buffer or reaction reagent. Therefore, it requires a period of time to allow the molecules in the solution to diffuse uniformly or to provide an active disturbance (such as using a shaker or pipetting up and down with a micropipette) to uniformly distribute the reaction components in the reagent. If the uneven concentration distribution caused by re-dissolving the lyophilized reagent is not solved, the reaction efficiency between the reagent and the reactant will be reduced, and the consistency of the reaction results will be reduced, thus affecting the interpretation of the test results.

Therefore, how to obviate the defects of the above-mentioned conventional technologies is an issue that needs to be overcome.

### SUMMARY OF THE INVENTION

An object of the present disclosure is to provide a nucleic acid detection device, which proposes an improved design for reagent mixing in order to solve the problem of uneven concentration distribution after the lyophilized reagent is re-dissolved.

In accordance with an aspect of the present disclosure, a nucleic acid detection device is provided. The nucleic acid detection device includes a plurality of tube holders, an illumination module, a detection module and a driving module. The plurality of tube holders are used for accommodating a plurality of tubes, and each of the plurality of tubes contains a reagent and a magnetizable element. The illumination module is disposed on one side of the plurality of tube holders and includes a plurality of light sources, a magnet and a casing, wherein the plurality of light sources and the magnet are installed on the casing. The detection module is disposed on an opposite side of the plurality of tube holders relative to the illumination module. The driving module includes a motor, a lead screw and a slider, wherein the lead screw is coupled to the motor and driven by the motor to rotate, and the slider is sleeved on the lead screw and has a reciprocating linear motion in response to a rotation of the lead screw. The illumination module is coupled to and moved together with the slider, so that the plurality of light sources and the magnet are synchronously driven by the motor and have reciprocating linear motions in a direction parallel to the lead screw. The magnetizable element in each of the plurality of tubes maintains at a first position when the magnet is driven to be not aligned with the tube, while when the magnet is driven to be aligned with one of the plurality of tubes, the magnetizable element in the aligned tube is attracted by the magnet to move from the first position to a second position, thereby mixing the reagent in the aligned tube.

In an embodiment, the first position is approximately at a bottom of the tube, and the second position is a position close to the magnet.

In an embodiment, the reagent is a lyophilized reagent.

In an embodiment, the magnetizable element is made of a metal material.

In an embodiment, the magnetizable element has a spherical shape with a diameter of 0.5˜2 mm.

In an embodiment, the magnet is a NdFeB magnet.

In an embodiment, the magnet has a maximum magnetic energy product of 45˜55 MGOe, a cross-sectional area of 1.5˜3.5 mm2, and a length of 1˜8 mm.

In an embodiment, a vertical distance between the magnet and a top of the casing is ranged between 2.5˜3.5 mm.

In an embodiment, the number of the magnet is one single.

In an embodiment, an installation position of the magnet is misaligned with installation positions of the plurality of light sources.

In an embodiment, the driving module further includes a carrier coupled to and moved together with the slider.

In an embodiment, the illumination module is carried on the carrier.

In an embodiment, the driving module further includes a photoelectric sensor, and the carrier includes an alignment fin on which at least one slit is provided for determining whether the plurality of light sources are aligned with at least one of the plurality of tubes.

In an embodiment, the driving module further includes a linear guide disposed in parallel to the lead screw, and the carrier is slidably disposed on the linear guide.

In an embodiment, the slider includes a nut screwed on the lead screw.

In an embodiment, an arrangement direction of the plurality of tube holders is parallel to the lead screw.

In an embodiment, each of the plurality of tubes includes a ring-shaped paraffin layer on a top of the reagent.

In an embodiment, the illumination module further includes a cover for accommodating a plurality of optical filters.

In an embodiment, the detection module includes a plurality of lens sets, a plurality of optical filters, and a plurality of photodetectors.

In an embodiment, the nucleic acid detection device further includes a temperature control module having a thermoelectric cooling chip.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 shows a schematic view of the nucleic acid detection device of the present disclosure;

FIG. 2 shows a schematic view of partial structures of the nucleic acid detection device in FIG. 1;

FIG. 3 shows the A-A′ cross-sectional view of FIG. 2;

FIG. 4A shows a schematic view of the illumination module of the present disclosure;

FIG. 4B shows the B-B′ cross-sectional view of FIG. 4A;

FIG. 4C shows the exploded view of FIG. 4A;

FIG. 5A shows a schematic view of the illumination module according to another embodiment of the present disclosure;

FIG. 5B shows the C-C′ cross-sectional view of FIG. 5A;

FIG. 5C shows the exploded view of FIG. 5A;

FIGS. 6 and 7 show schematic views of the illumination module and the driving module of the present disclosure;

FIG. 8 shows a schematic view of the carrier in the present disclosure;

FIGS. 9A and 9B show schematic views that the magnet is not aligned with the tube;

FIGS. 10A and 10B show schematic views that the magnet is aligned with the tube;

FIGS. 11A to 11F show schematic views of the sequential alignments of the magnet and the tubes;

FIGS. 12A to 12F show schematic views of the sequential alignments of the light sources and the tubes;

FIGS. 13A to 13C show the magnetic mixing effects in an exemplary embodiment; and

FIGS. 14A to 14C show the magnetic mixing effects in another exemplary embodiment.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. The drawings of all the embodiments of the present disclosure are merely schematic and do not represent true dimensions and proportions.

The present disclosure provides a nucleic acid detection device, which proposes an improved design for reagent mixing to solve the problem of uneven concentration distribution after the lyophilized reagent is re-dissolved, especially to solve the problems of fluorescence baseline drift and inconsistent detection results, which are caused by the uneven concentration distribution, in the real-time polymerase chain reaction (qPCR). In view of the fact that the conventional magnetic mixing technology greatly increases the equipment volume and cost for the mechanical setup, the present disclosure integrates the magnet into the illumination module required for nucleic acid detection, so that the magnet and the illumination module can be driven together to simplify the mechanical setup. According to this concept, the present disclosure employs the magnetic field contributed by a single magnet, which moves along a single axis, to drive the magnetizable element in the reaction tube to move, thereby providing a driving force of active disturbance to the reagent in the reaction tube, so as to achieve uniform concentration distribution of the regent in the reaction tube.

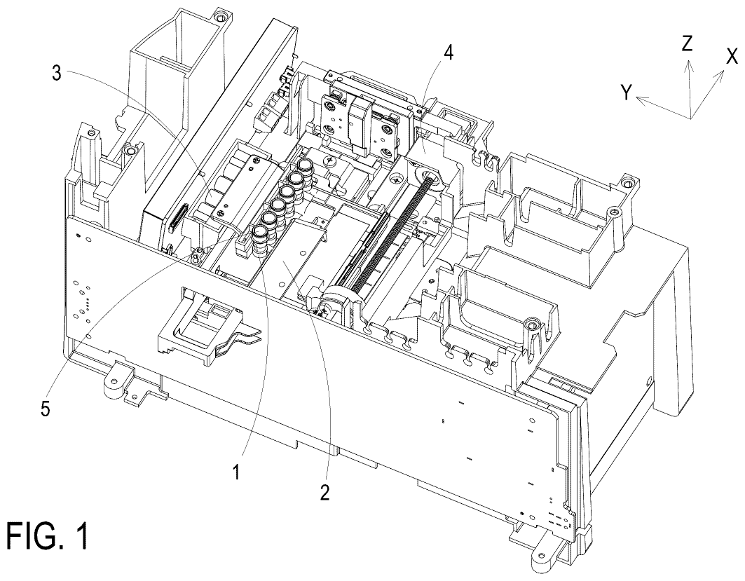

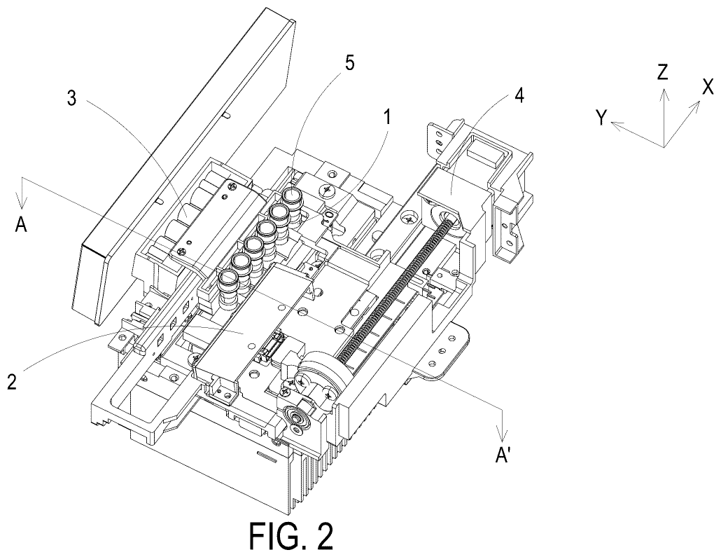

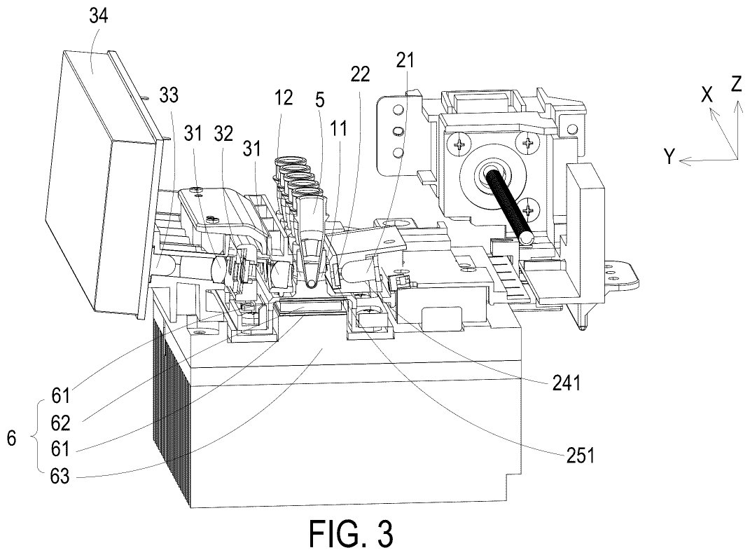

FIG. 1 shows a schematic view of the nucleic acid detection device of the present disclosure, FIG. 2 shows a schematic view of partial structures of the nucleic acid detection device in FIG. 1, and FIG. 3 shows the A-A′ cross-sectional view of FIG. 2. As shown in FIGS. 1 to 3, the nucleic acid detection device of the present disclosure mainly includes a plurality of tube holders 1, an illumination module 2, a detection module 3, and a driving module 4. The plurality of tube holders 1 are made of metal material and are arranged in a straight line along the X-axis for accommodating a plurality of tubes (such as PCR reaction tubes) 5, and thus the plurality of tubes 5 are also arranged in a straight line. The illumination module 2 and the detection module 3 are respectively disposed on two opposite sides of the plurality of tube holders 1, that is, respectively disposed on two opposite sides of the plurality of tubes 5. The illumination module 2 provides light with required wavelength to excite the fluorescent substance in the tube 5, and then the detection module 3 receives the fluorescence emitted by the fluorescent substance to achieve the purpose of nucleic acid detection. The driving module 4 drives the movement of the illumination module 2 to align with the tubes 5.

In an embodiment, the illumination module 2 includes a plurality of optical channels, and the distance between two adjacent optical channels is approximately equal to the distance between two adjacent tubes. Each optical channel of the illumination module 2 includes a light source 21 and an optical filter 22. The detection module 3 also includes a plurality of optical channels, and the distance between two adjacent optical channels is approximately equal to the distance between two adjacent tubes 5. Each optical channel of the detection module 3 includes a lens set 31, an optical filter 32, and a photodetector 33. The photodetector 33 is further coupled to a signal acquisition circuit board 34. The light source 21 is but not limited to a light emitting diode. The detection light is provided by the light emitting diode of a specific wavelength, and is incident to the tube 5 through the optical filter 22 and the light inlet 11 of the tube holder 1, thereby exciting the fluorescent substance in the tube 5. The fluorescence generated by the amplification reaction is emitted through the light outlet 12 of the tube holder 1 and collected through the lens set 31, the optical filter 32, and the photodetector 33, and then sensed by the back-end signal acquisition circuit board 34 and converted into a readable value.

In an embodiment, the nucleic acid detection device of the present disclosure further includes a temperature control module 6 for providing different temperatures required for the amplification reaction and promoting the nucleic acid molecules and the reaction reagents to perform denaturation, annealing and extension steps in continuous cycles, so as to complete the nucleic acid amplification. As shown in FIG. 3, the temperature control module 6 includes a thermal pad 61, a thermoelectric cooling (TEC) chip 62, a heat sink 63 and a cooling fan (not shown). In addition, the tuber holder 1 is made of metal material, such as copper with excellent thermal conductivity. Therefore, the tuber holder 1 is not only used to accommodate the tube 5, but also used to conduct the heat generated by the TEC chip 62 to facilitate the PCR reaction.

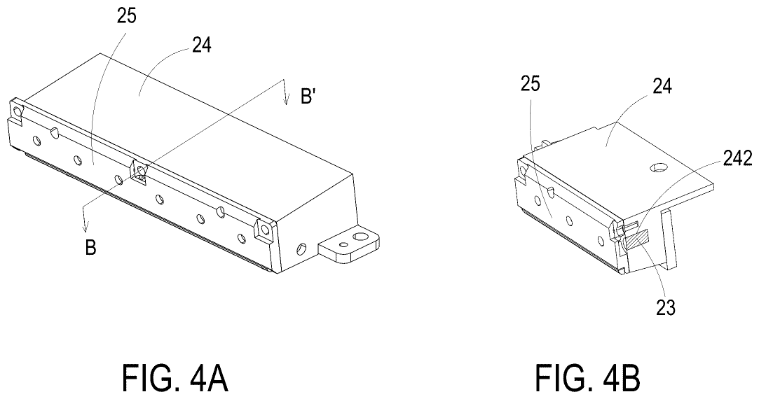

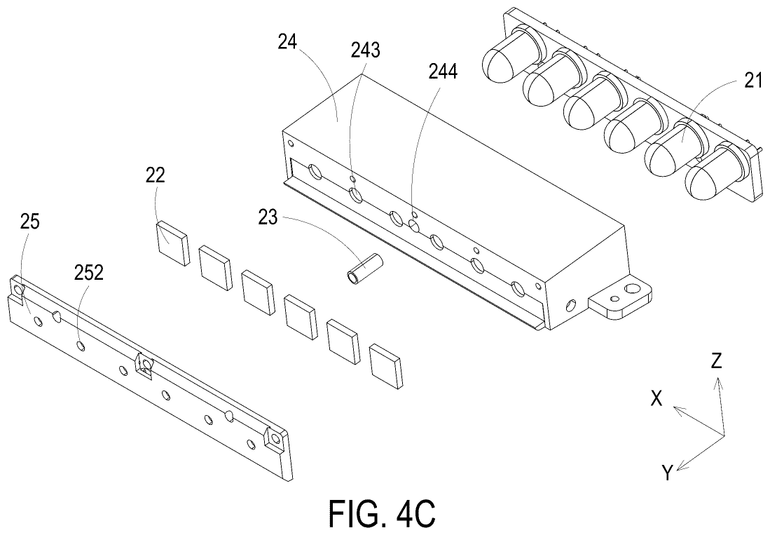

FIG. 4A shows a schematic view of the illumination module of the present disclosure, FIG. 4B shows the B-B′ cross-sectional view of FIG. 4A, and FIG. 4C shows the exploded view of FIG. 4A. As shown in FIGS. 4A to 4C, except for the aforementioned light source 21 and optical filter 22, the illumination module 2 of the present disclosure further includes a magnet 23, a casing 24, and a cover 25. The casing 24 includes a plurality of recesses 241 (shown in FIG. 3) for respectively accommodating the plurality of light sources 21, and a slot 242 for accommodating the magnet 23. Therefore, the light sources 21 and the magnet 23 are both installed and fixed on the casing 24, wherein the installation position of the magnet 23 is misaligned with the installation positions of the light sources 21, and is substantially located in the middle of two adjacent light sources 21 in the X-axis direction. The casing 24 further includes a plurality of light outlets 243 corresponding to the plurality of light sources 21, and an opening 244 corresponding to the magnet 23. The cover 25 includes a plurality of indentations 251 (shown in FIG. 3) for accommodating the plurality of optical filters 22, and a plurality of light outlets 252 corresponding to the plurality of optical filters 22. The light outlet 243 of the casing 24 and the light outlet 252 of the cover 25 are aligned with each other in each optical channel.

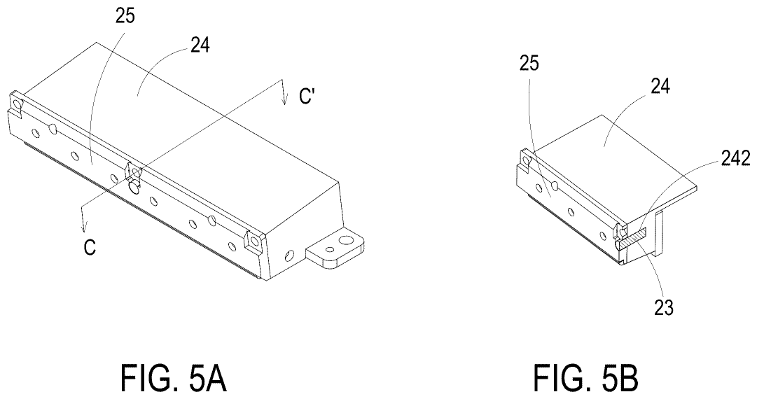

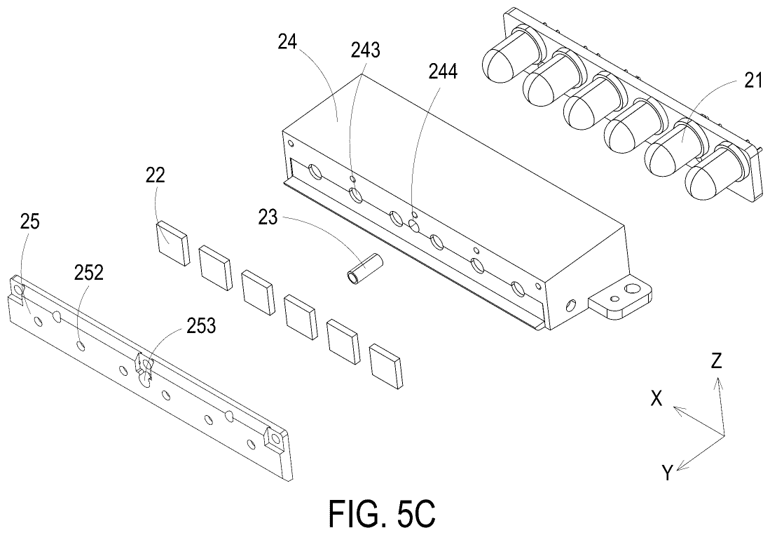

In the aforementioned embodiment, the magnet 23 is shielded by the cover 25. However, in another embodiment, the magnet 23 can also be exposed without being shielded by the cover 25. FIG. 5A shows a schematic view of the illumination module according to another embodiment of the present disclosure, FIG. 5B shows the C-C′ cross-sectional view of FIG. 5A, and FIG. 5C shows the exploded view of FIG. 5A. As shown in FIGS. 5A to 5C, the cover 25 further includes an opening 253 corresponding to the magnet 23, which is aligned with the opening 244 of the casing 24, so that the magnet 23 on the illumination module 2 is exposed without being shielded by the cover 25 and can be closer to the tube 5 for magnetic mixing.

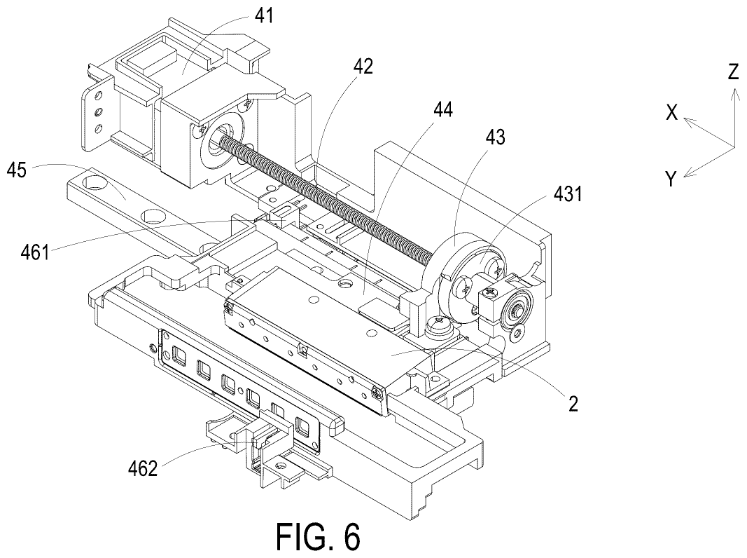

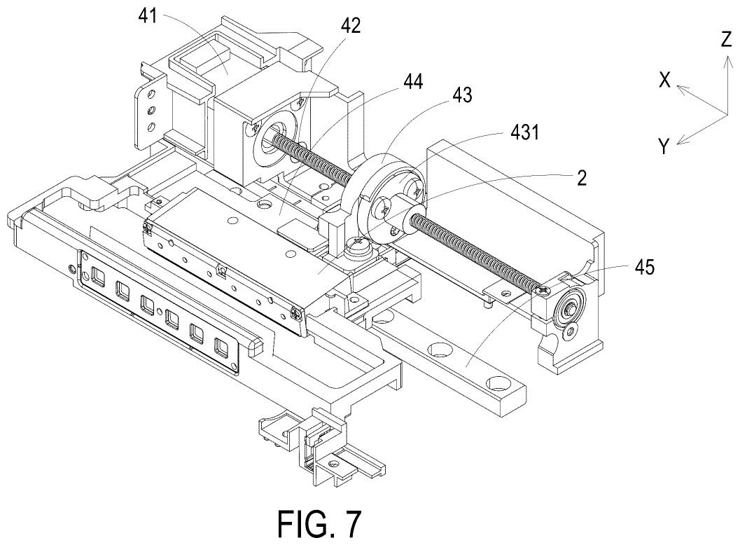

FIGS. 6 and 7 show schematic views of the illumination module and the driving module of the present disclosure, wherein the illumination module is driven by the driving module to be in different positions. As shown in FIGS. 6 and 7, the driving module 4 is a linear slide assembly, which mainly includes a motor 41, a lead screw 42 and a slider 43. The lead screw 42 is coupled to the motor 41 and is driven by the motor 41 to rotate. The slider 43 is sleeved on the lead screw 42 and has a reciprocating linear motion on the lead screw 42 in response to the rotation of the lead screw 42. The illumination module 2 is coupled to the slider 43 and moved together with the slider 43, so that the light sources 21 and the magnet 23 on the illumination module 2 are synchronously driven by the motor 41 and have reciprocating linear motions in a direction parallel to the lead screw 42 (X-axis direction). In other words, the arrangement direction of the plurality of tube holders 1, the arrangement direction of the plurality of tubes 5, and the axial direction of the lead screw 42 are all parallel to the X-axis direction, and the light sources 21 and the magnet 23 on the illumination module 2 are moved along this single axis. Certainly, the design of the driving module 4 to drive the illumination module 2 may be modified according to different requirements and is not limited to the embodiments described in the present disclosure.

In an embodiment, the motor 41 is a stepper motor, which is able to programmatically control the movement mode of the illumination module 2, but is not limited thereto.

In an embodiment, the slider 43 includes a nut 431, which is screwed on the lead screw 42, thereby driving the slider 43 to have the reciprocating linear motion on the lead screw 42.

In an embodiment, the driving module 4 further includes a carrier 44 and a linear guide 45, and the linear guide 45 and the lead screw 42 are arranged in parallel. The carrier 44 is coupled to and moved together with the slider 43, and is slidably disposed on the linear guide 45. The illumination module 2 is carried on the carrier 44, and thus is coupled to and moved together with the slider 43, so that the light sources 21 and the magnet 23 on the illumination module 2 are synchronously driven by the motor 41 to have reciprocating linear motions in the direction parallel to the lead screw 42 (X-axis direction).

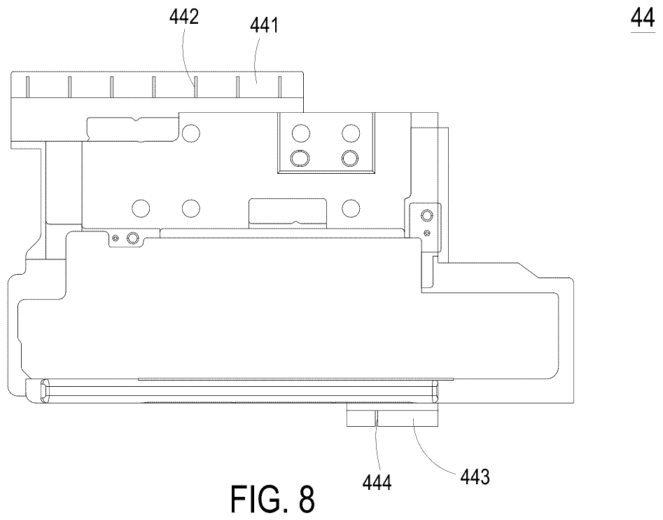

In an embodiment, the driving module 4 further includes an alignment structure design for determining whether the light source 21 is aligned with the tube 5. Please refer to FIGS. 6 to 8, wherein FIG. 8 shows a schematic view of the carrier in the present disclosure. As shown in FIGS. 6 to 8, the driving module 4 includes a first photoelectric sensor 461, which is a photointerrupter and has a light-emitting element and a light-receiving element disposed oppositely to each other. When a light-shielding part or a light-transmitting part of an object passes through the photointerrupter, a current change occurs depending on whether the light path of the photointerrupter is blocked or not. The carrier 44 includes a first alignment fin 441 on which a plurality of slits 442 are provided, and the distance between two adjacent slits 442 is approximately equal to the distance between two adjacent tubes 5. When the slit 442 passes through the first photoelectric sensor 461, the first photoelectric sensor 461 detects that the light path is not blocked, indicating that at least one light source 21 is aligned with the tube 5, and the magnet 23 is not aligned with the tube 5. In this circumstance, the light source 21 can be switched on to emit the detection light. Through the design of the alignment structure, the magnetic mixing and the optical detection can be separated to avoid blocking the optical path by the magnetic mixing during the optical detection, which affects the acquisition of detection data.

In an embodiment, the driving module 4 further includes a second photoelectric sensor 462, and the carrier 44 includes a second alignment fin 443 provided with a slit 444 thereon. The slit 444 is provided for positioning the zero point. When the slit 444 passes through the second photoelectric sensor 462, the second photoelectric sensor 462 detects that the light path is not blocked, indicating that the carrier 44 has returned to the origin of the reciprocating linear motion (as shown in FIG. 6).

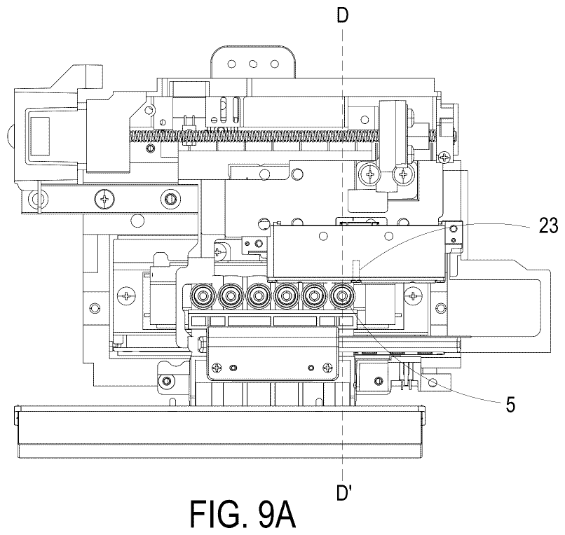

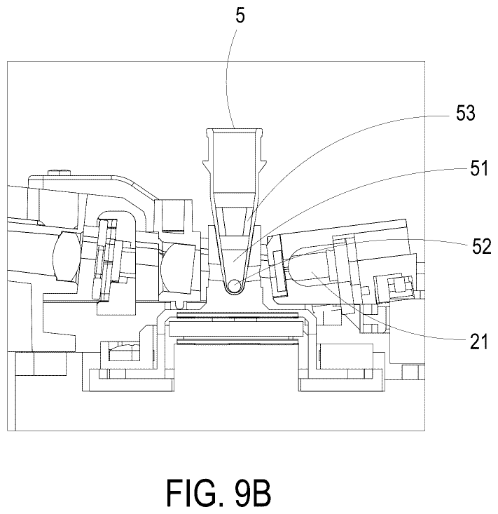

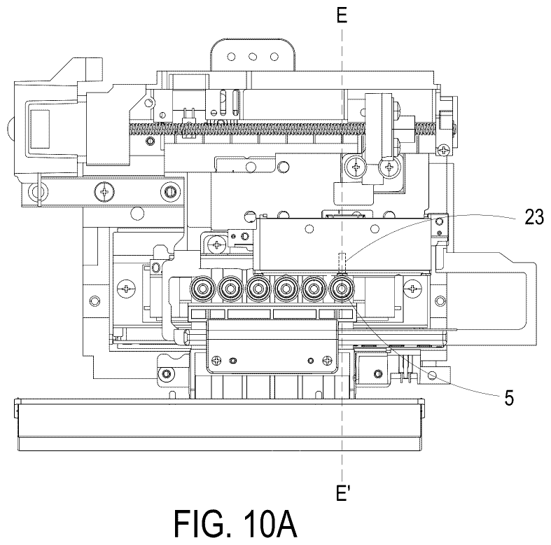

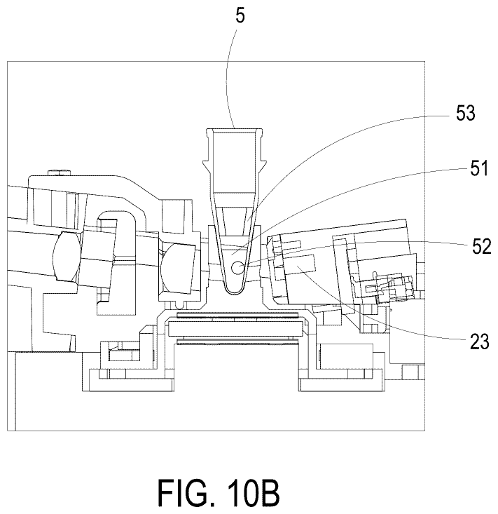

The magnetic mixing mechanism of the present disclosure will be further illustrated below with reference to FIGS. 9A, 9B, 10A and 10B. FIGS. 9A and 9B show schematic views that the magnet is not aligned with the tube, and FIG. 9B shows partial D-D′ cross-sectional view of FIG. 9A. While FIGS. 10A and 10B show schematic views that the magnet is aligned with the tube, and FIG. 10B shows partial E-E′ cross-sectional view of FIG. 10A.

First of all, the tube 5 is made of polymer material and is a conical container that opens upward and has wider top part and narrower bottom part. The tube holder 1 is also a structure that opens upward and has wider top part and narrower bottom part, and its inner diameter is designed to conform to and fit tightly to the tube 5. The tube 5 primarily contains the reagents 51 and the magnetizable element 52. The reagents 51 include but are not limited to PCR reaction reagents, particularly the lyophilized PCR reaction reagents. The reagents include nucleotides, primers, probes, enzymes, sugars, and stabilizers. The tube 5 further includes a ring-shaped paraffin layer 53 on the top of the reagent 51. This ring-shaped structure allows addition of the test solution, such as nucleic acid extraction solution, from the center thereof. Then the ring-shaped paraffin layer 53 is melted by the temperature control module 6 to cover the surface of the reaction solution and form an isolation layer, so as to prevent evaporation of the reaction solution during the temperature control cycle and prevent amplification products from escaping into the environment and causing contamination.

In an embodiment, the magnetizable element 52 is made of metal material, and its surface is usually covered with a layer of corrosion-resistant material (such as nickel, chromium, molybdenum or polymer material) to avoid contact with the reagent 51 and prevent oxidation reactions. The magnetizable element 52 will naturally sink to the bottom of the tube 5 by gravity. The outer shape of the magnetizable element 52 can be, but is not limited to, spherical, square, or cylindrical. The spherical shape is preferred because it can conform to and stay closely to the bottom of the tube 5 to reduce the generation of air bubbles. The diameter of the spherical shape is between 0.5˜2 mm, such as 0.5, 0.58, 0.8 or 2 mm. For example, the magnetizable element 52 may be a steel ball.

When the illumination module 2 embedded with the magnet 23 is driven by the driving module 4 and the center of the magnet 23 deviates from the normal line of the tube 5 (that is the magnet 23 is not aligned with the tube 5), the magnetizable element 52 in the tube 5 is not actuated by the magnetic field and is naturally maintained at a first position due to its own mass, that is, approximately at the bottom of the tube 5 (as shown in FIGS. 9A and 9B). While when the illumination module 2 embedded with the magnet 23 is driven by the driving module 4 and the center of the magnet 23 is aligned with the normal line of an individual tube 5 (that is the magnet 23 is aligned with the tube 5), the magnetic field contributed by the magnet 23 will drive the magnetizable element 52 in the tube 5 to move from the first position to a second position, that is, moves upward from the bottom of the tube 5 to a position close to the magnet 23 (as shown in FIGS. 10A and 10B). When the driving module 4 drives the magnet 23 to move to the next tube 5, the center of the magnet 23 deviates from the normal line of the original tube 5, so the magnetizable element 52 that was originally attracted by the magnet 23 and moved to the second position is no longer magnetically attracted and naturally sinks back to the first position due to its own mass. Therefore, through programmable and repeated movements and alignments, the magnetizable element 52 in the tube 5 is driven to move, thereby providing the driving force of active disturbance to the reagent 51 in the tube 5 to achieve uniform concentration distribution of the reagent 51 in the tube 5.

The normal line of the tube 5 is referred to the straight line which is perpendicular to the tangent at the outmost point of the tube 5 facing the illumination module 2. In other words, the normal line of the tube 5 means the line passing through the center of the tube 5 and perpendicular to the arrangement direction of the tubes 5 (X-axis direction).

The foregoing embodiments are illustrated with the illumination module 2 embedded with a single magnet 23 as an example, but is not limited thereto. The magnetic mixing of the reagent 51 in the tube 5 can be adjusted by programmatically controlling the dwell time and the number of cyclic movements of the magnet 23 along the plurality of tubes 5. For example, the dwell time can be set as 0 seconds, 200 milliseconds, 300 milliseconds, 400 milliseconds, 500 milliseconds, 600 milliseconds, 700 milliseconds, 800 milliseconds, 900 milliseconds or 1 second. The number of cyclic movements can be set as 10 times, 20 times or 30 times. These parameters can be adjusted according to different requirements and are not limited to those described in the embodiments of the present disclosure.

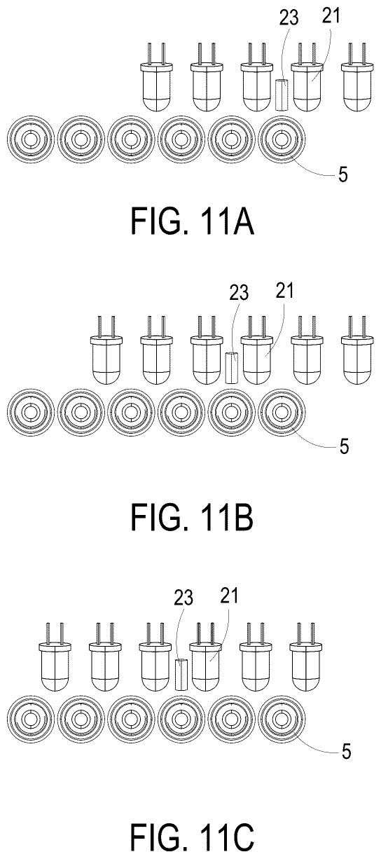

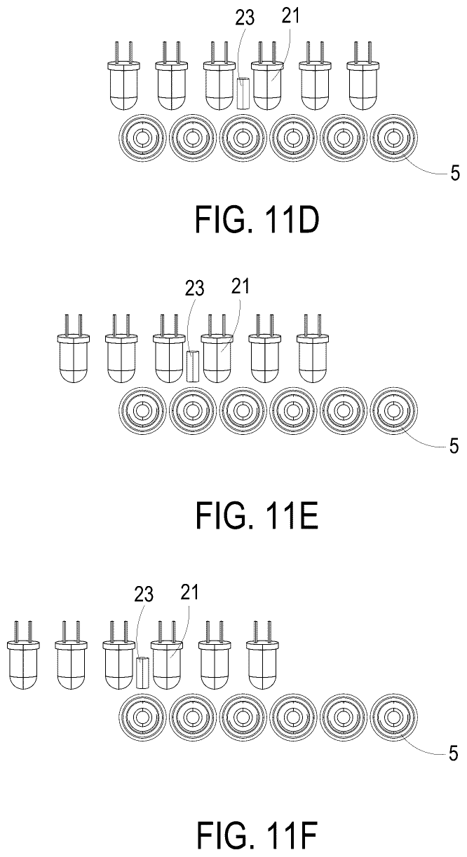

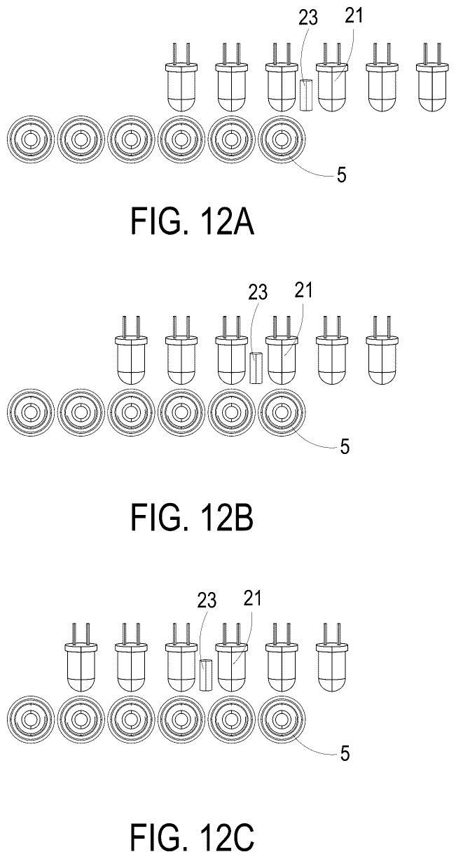

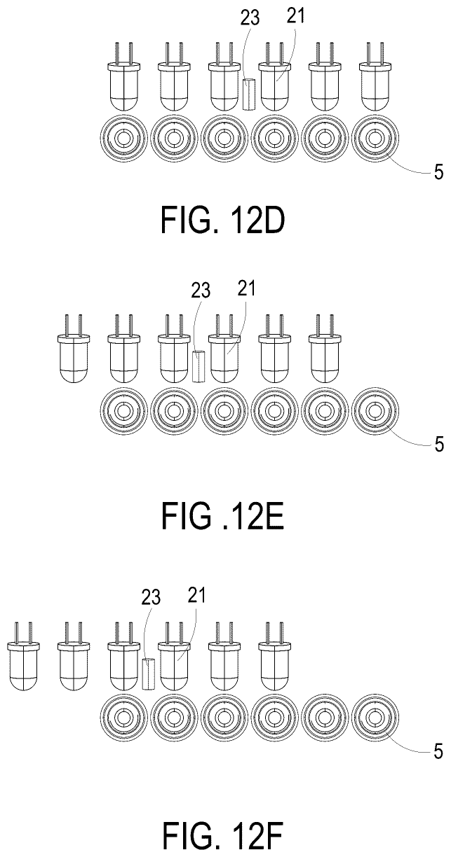

According to the design of the nucleic acid detection device in the present disclosure, when the tubes 5 containing the test solutions are placed in the tube holders 1, the illumination module 2 is driven in a programmable manner by the driving module 4, and the alignment structure is used to determine whether the light sources 21 are aligned with the tubes 5 to control the switch of the light sources 21, so as to prevent the magnetizable element 52 from blocking the optical path for detection due to being magnetically attracted and moving in the tube 5, which affects the detection data acquisition during the optical detection. For example, the nucleic acid detection device first performs the magnetic mixing operation. As shown in FIGS. 11A to 11F, the magnet 23 is driven to be sequentially aligned with each tube 5 to mix the reagents in the tubes 5, and can be moved cyclically to fully mix the reagents in the tubes 5. Then, the temperature control module 6 is used to provide optimal temperatures for amplifying the nucleic acid molecules in the tubes 5. After the amplification is completed, the driving module 4 drives the alignment of the light sources 21 and the tubes 5, and the light sources 21 are turned on in the alignment state for optical detection, and as shown in FIGS. 12A to 12F, the light sources 21 are driven to be sequentially aligned with the tubes 5. During the optical detection operation, the individual light source 21 is aligned with the normal line of the individual tube 5, while during the magnetic mixing operation, the center of the magnet 23 is aligned with the normal line of the individual tube 5, thereby creating the possibility that the light sources 21 and the magnet 23 can be installed on the same mechanism and their functions do not interfere with each other, which greatly reduces the complexity of the mechanism.

In an embodiment, the magnet 23 is a neodymium magnet (also known as NdFeB magnet) made from an alloy of neodymium, iron, and boron. The maximum magnetic energy product ((BH) max) is ranged between 45˜55 MGOe. The cross-sectional area of the magnet 23 is ranged between 1.5˜3.5 mm². The length of the magnet 23 is ranged between 1˜8 mm. The vertical distance between the magnet 23 and the top of the casing 24 is ranged between 2.5˜3.5 mm.

In an embodiment, the number of the magnet 23 is one single, and the magnet 23 is approximately embedded in the center of the casing 24. Since the magnet 23 is driven by the driving module 4 to move and align with each tube 5 individually, only one single magnet 23 is necessary to achieve the magnetic mixing of all tubes 5. Of course, the number of the magnet 23 is not limited to one, and can also be two or more, thereby shortening the moving distance of the illumination module 2.

The following is an exemplary embodiment used to illustrate the magnetic mixing effect of the nucleic acid detection device in the present disclosure. In this exemplary embodiment, the nucleic acid detection device is provided with one single magnet 23, which is NdFeB magnet and has a maximum magnetic energy product ((BH) max) of 50˜53 MGOe, a cross-sectional area of 2 mm² and a length of 6 mm. The magnet 23 is located at the center of the casing 24 and has a vertical distance of 2.5 mm from the top of the casing 24, so that when the magnetizable element 52 actuated by the magnetic field moves to the second position, it is just close to and located at the bottom of the paraffin isolation layer. The magnetizable element 52 contained in the tube 5 has a spherical shape with a diameter of 0.58 mm, and is made of 440 series stainless steel. When the magnet 23 is driven to cyclically move along the plurality of tubes 5, the dwell time of the individual tube 5 is set as 200 milliseconds, and the mixing times of the individual tube 5 is set as 10, 20 and 30 times.

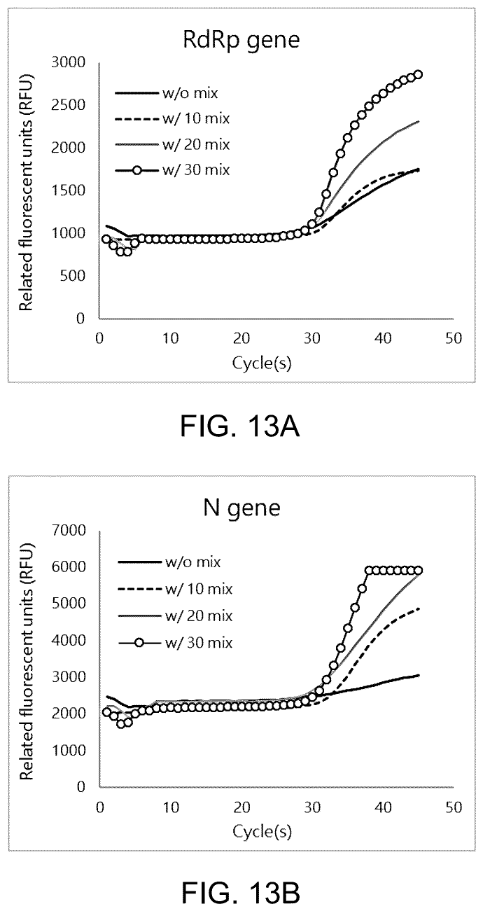

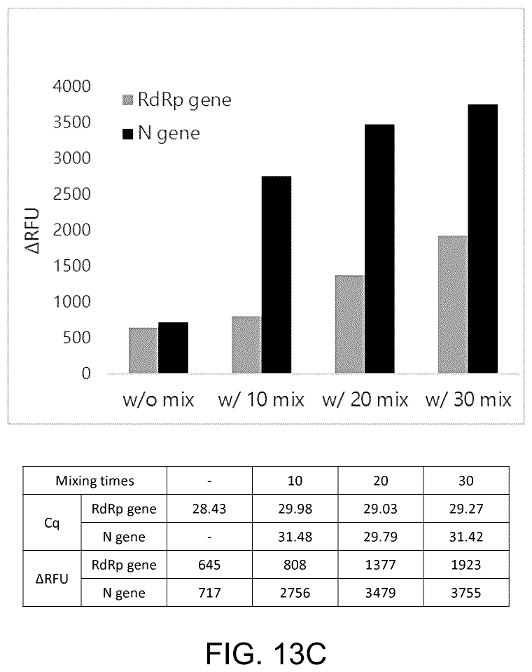

In this exemplary embodiment, the reagent used for detection is 25 μL SARS-COV-2 lyophilized reagent (lyophilized-cake). The nucleic acid detection device of the present disclosure is used with a nucleic acid extraction cartridge to perform extraction to a SARS-COV-2 standard and then perform RT-PCR for detecting the RdRp gene and the N gene of the virus. The viral transport medium (VTM) is used as the substrate to prepare a sample containing 750 cp/mL SARS-COV-2 standard and 3×10\hat{ }4 human cells, and 0.4 mL of the sample is used for the following test. When the extraction is completed, the magnetic mixing mechanism is set as: no mixing, mixing 10 times, mixing 20 times, and mixing 30 times, respectively, and then the subsequent nucleic acid amplification and the optical detection are performed. FIGS. 13A to 13C show the magnetic mixing effects in this exemplary embodiment, wherein FIG. 13A shows the RT-PCR amplification curves of the RdRp gene, FIG. 13B shows the RT-PCR amplification curves of the N gene, and FIG. 13C shows the Cq values and the amplified fluorescence values (ARFU). As shown in the figures, as the mixing times increase, the fluorescence signal gradually increases and forms a typical S-shaped amplification curve. Then the regression model is used to calculate the Cq value and amplified fluorescence values (ARFU). The results shown in FIG. 13C indicate that the magnetic mixing mechanism of the nucleic acid detection device in the present disclosure indeed improves the reaction performance.

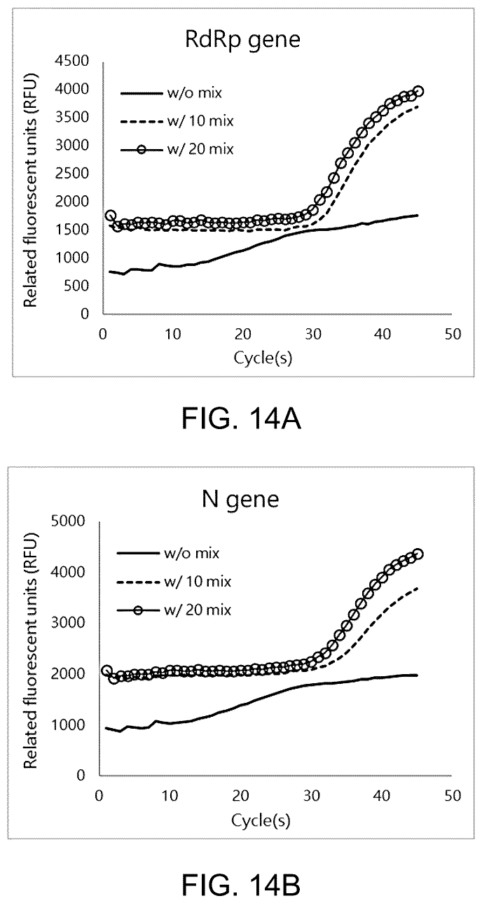

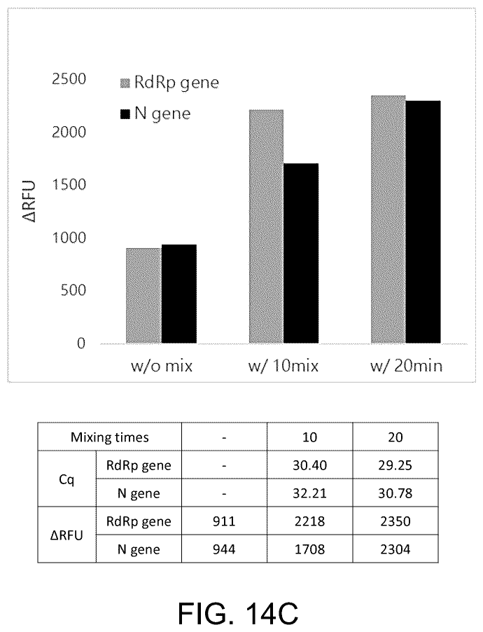

In order to verify the feasibility again, in another exemplary embodiment, a magnetic mixing test is performed with 10 μL SARS-COV-2 lyophilized reagent (lyophilized-cake), in which the sample includes 1,000 cp/mL SARS-COV-2 standard and 3×10\hat{ }4 human cells, and 0.4 mL of the sample is used for the following test. FIGS. 14A to 14C show the magnetic mixing effects in this exemplary embodiment, wherein FIG. 14A shows the RT-PCR amplification curves of the RdRp gene, FIG. 14B shows the RT-PCR amplification curves of the N gene, and FIG. 14C shows the Cq values and the amplified fluorescence values (ARFU). As shown in the figures, when 10 μL lyophilized reagent is not mixed, the RT-PCR amplification curve is flat with no significant amplification, and neither the RdRp gene nor the N gene can be detected. As the mixing times increase to 10 and 20 times, the fluorescence signal is significantly enhanced.

The above verification results also show that when the volume of the lyophilized reagent is reduced and thus is relatively dense, the concentration gradient may become larger after re-dissolve, making the reagent more difficult to homogenize. By using the magnetic mixing mechanism of the present disclosure, it indeed effectively accelerates the mixing of the reagent to satisfy the subsequent PCR results. Therefore, the magnetic mixing mechanism of the present disclosure has the effect of promoting the mixing of PCR reaction solution.

In conclusion, the present disclosure provides the nucleic acid detection device including the plurality of tube holders, the illumination module, the detection module and the driving module. The magnet is integrated into the illumination module so that the magnet and the illumination module are driven together to simplify the mechanism setup. In other words, in addition to providing the excitation light required for PCR fluorescence detection, the illumination module is further embedded with the magnet for magnetic mixing the reagents in the tubes. With the action of the driving module, the magnet moves along the single axis parallel to the arrangement direction of the tubes. By programmable and repeated movements and alignments, the magnetizable element in the tube is driven to move, thereby providing the driving force of active disturbance to the reagent and promoting the uniform concentration distribution of the reagent in the tube, so as to improve the reaction efficiency and consistent reaction results, and avoid the significant increase in equipment volume and cost.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A nucleic acid detection device, comprising:
a plurality of tube holders for accommodating a plurality of tubes, wherein each of the plurality of tubes contains a reagent and a magnetizable element;
an illumination module disposed on one side of the plurality of tube holders and comprising a plurality of light sources, a magnet and a casing, wherein the plurality of light sources and the magnet are installed on the casing;
a detection module disposed on an opposite side of the plurality of tube holders relative to the illumination module; and
a driving module comprising a motor, a lead screw and a slider, wherein the lead screw is coupled to the motor and driven by the motor to rotate, and the slider is sleeved on the lead screw and has a reciprocating linear motion in response to a rotation of the lead screw,
wherein the illumination module is coupled to and moved together with the slider, so that the plurality of light sources and the magnet are synchronously driven by the motor and have reciprocating linear motions in a direction parallel to the lead screw,
wherein the magnetizable element in each of the plurality of tubes maintains at a first position when the magnet is driven to be not aligned with the tube, while when the magnet is driven to be aligned with one of the plurality of tubes, the magnetizable element in the aligned tube is attracted by the magnet to move from the first position to a second position, thereby mixing the reagent in the aligned tube.

2. The nucleic acid detection device according to claim 1, wherein the first position is approximately at a bottom of the tube, and the second position is a position close to the magnet.

3. The nucleic acid detection device according to claim 1, wherein the reagent is a lyophilized reagent.

4. The nucleic acid detection device according to claim 1, wherein the magnetizable element is made of a metal material.

5. The nucleic acid detection device according to claim 1, wherein the magnetizable element has a spherical shape with a diameter of 0.5˜2 mm.

6. The nucleic acid detection device according to claim 1, wherein the magnet is a NdFeB magnet.

7. The nucleic acid detection device according to claim 1, wherein the magnet has a maximum magnetic energy product of 45˜55 MGOe, a cross-sectional area of 1.5˜3.5 mm², and a length of 1˜8 mm.

8. The nucleic acid detection device according to claim 1, wherein a vertical distance between the magnet and a top of the casing is ranged between 2.5˜3.5 mm.

9. The nucleic acid detection device according to claim 1, wherein the number of the magnet is one single.

10. The nucleic acid detection device according to claim 1, wherein an installation position of the magnet is misaligned with installation positions of the plurality of light sources.

11. The nucleic acid detection device according to claim 1, wherein the driving module further comprises a carrier coupled to and moved together with the slider.

12. The nucleic acid detection device according to claim 11, wherein the illumination module is carried on the carrier.

13. The nucleic acid detection device according to claim 11, wherein the driving module further comprises a photoelectric sensor, and the carrier comprises an alignment fin on which at least one slit is provided for determining whether the plurality of light sources are aligned with at least one of the plurality of tubes.

14. The nucleic acid detection device according to claim 11, wherein the driving module further comprises a linear guide disposed in parallel to the lead screw, and the carrier is slidably disposed on the linear guide.

15. The nucleic acid detection device according to claim 1, wherein the slider comprises a nut screwed on the lead screw.

16. The nucleic acid detection device according to claim 1, wherein an arrangement direction of the plurality of tube holders is parallel to the lead screw.

17. The nucleic acid detection device according to claim 1, wherein each of the plurality of tubes comprises a ring-shaped paraffin layer on a top of the reagent.

18. The nucleic acid detection device according to claim 1, wherein the illumination module further comprises a cover for accommodating a plurality of optical filters.

19. The nucleic acid detection device according to claim 1, wherein the detection module comprises a plurality of lens sets, a plurality of optical filters, and a plurality of photodetectors.

20. The nucleic acid detection device according to claim 1, further comprising a temperature control module having a thermoelectric cooling chip.
